(19) United States
(12) Patent Application Publication
(10) Pub. No.: US 2001/0039592 A1
(43) Pub. Date: Nov. 8, 2001

(54) Web address assignment process

(76) Inventor: Francis W. Carden, Norcross, GA (US)

Correspondence Address: Charles W. Forlidas, Miller & Martin LLP, 1000 Volunteer Building, 832 Georgia Avenue, Chattanooga, TN, 37402, US

(21) Appl. No.: 09/790,177

(22) Filed: Feb. 22, 2001

Related U.S. Application Data
(60) Provisional application No. 60/184,521, filed on Feb. 24, 2000.

(51) Int. Cl. G06F 15/16

(52) U.S. Cl. 709/245; 709/219

(57) ABSTRACT

A method of assigning a web address to an entity includes the steps of accessing a server, providing a telephone number associated with said entity to a server, formulating a web address including the telephone number as at least a portion of the web address, and assigning the web address to the entity.

### RELATED APPLICATION

This application claims priority to provisional application Serial No. 60/184,521 filed Feb. 24, 2000.

### BACKGROUND OF THE INVENTION

1. Field of the Invention

The present invention relates to the addressing of resources or other objects on the Internet. Web addresses, also known by the generic acronym URIs (for Uniform Resource Identifiers) and, less generically, URLs (for Uniform Resource Locators), are used by web browser programs to locate Internet resources, such as files, web sites or individual web pages. Web sites and web pages may be made up of a wide variety of resources of varying protocols and services which are well known in the art, such as Hypertext Markup Language (HTML) documents, Extensible Markup Language (XML) documents, Extensible Hypertext Markup Language (XHTML) documents, and the like.

The first part of a URL (address) indicates what protocol to use, and the second part specifies the IP address or the domain name where the resource is located. For example, the two URLs below point to two different files at the domain dialnow.com. The first specifies an executable file that should be fetched using the FTP protocol; the second specifies a web page that should be fetched using the HTTP protocol:

ftp://www.dialnow.com/start.exe

http://www.dialnow.com/index.html.

More specifically, the present invention provides a novel method for assigning web addresses on the Internet or another computer network using telephone numbers. The web addresses thus assigned are more easily accessible and rememberable.

2. Description of Related Art

The structure and functioning of the global computer network known as the Internet is well known. A web site comprising one or more HTML (or FTP, etc.) documents and associated files, scripts, and databases is served up by an HTTP (or FTP, etc.) server on the network. Users need a web browser and a network connection to access a web site. Users must also know or have access to a link connected to the web address for a particular web site or web page of a web site.

Presently, computer network addresses such as web addresses on the World Wide Web are typically selected by a consumer and registered with an authorized registering entity such as Network Solutions™ or Register.com™. The consumer or applicant typically submits a proposed web site address which is then checked against a database of existing registrations to determine whether or not that particular web site is available. If available, the registry will notify the applicant that that web site may be registered. Once registered, the registrant must then create at least one web page, such as an HTML document or other resource, to be located at the web address and install a server to host the web site for Internet accessibility.

Conventional web addressing and selection techniques have resulted in a number of problems. For example, company trademarks or the names of famous individuals may be registered and used verbatim or slightly modified by unscrupulous operators as web addresses for web pages the content of which the rightful owner of the mark would not approve. Furthermore, cyber-squatters may obtain a registration for a particular web address knowing that a particular company would benefit from that address, thus preventing the entity from being able to utilize that web page unless purchased or obtained through litigation from the cyber-squatter. Additionally, a plurality of people may want a single web site address for a number of different reasons. One example would include generic names of a particular product group, such as “www.furniture.com”.

Even if an entity is able to register a particularly desirable site, finding the site may present additional problems for the Internet literate community. A particular site for a company could be anything from the company initials to a partial spelling of the company name or even a generic name of a product offered by that company. Some companies may register a plurality of sites which are hosted to link accessors to the primary site for that company. Additionally, as more participants enter the Internet market, new addressing conventions are added at a rapid rate.

A different problem is encountered by individuals who desire to have their own personal web page. Such individuals usually must employ the services of a third party host to maintain their web site and the URLs for such individual sites often consist of a meaningless string of characters bearing little relation to the true identity of the web site owner.

Additionally, many individuals may not own their own personal computer or other device capable of achieving an internet connection and so would encounter difficulty in creating their own web site. However, as can be seen by the enormous and growing popularity of direct dial lines for employees in businesses, mobile phones and other telephonic hand held devices, it is not unrealistic to conceive of a point in the near future when virtually every adult (and most minors) in developed and developing countries will have or own a telephone or even a mobile phone with a unique telephone number identifying their phone, and by extension, themselves. The present invention provides a method of providing and assigning such individuals with their own web-page address and/or e-mail accounts by virtue of a commonplace and memorable identifier.

At least one company has registered a web site utilizing a portion of its telephone number. The web address www.1800flowers.com is registered to 1-800-FLOWERS.COM, Inc. of Westbury, N.Y. This company has apparently obtained the telephone number 1-800-356-9377 wherein the last seven digits correspond to the letters on the telephone dial to spell the word “flowers.” Another company, Nationwide Floral Services, has apparently registered the web address of www.18003569377.com. Should the consumer dial the 1-800-356-9377 number on the phone, they would reach the former company. As is illustrated by this scenario, a method for assigning web addresses which reduces potential consumer confusion is needed.

Additionally, some hosts provide e-mail accounts for individuals. Once again, applicants typically submit a proposed e-mail address such as “myname@theserver.com.” A number of companies such as Yahoo™, Mindspring™ and others host e-mail addresses submitted in this form. Once again, it is believed that problems may arise when two people desire the identical e-mail address for at least the reasons described above.

Accordingly, a need exists to provide a method for assigning web page addresses and e-mail addresses which may significantly reduce, if not eliminate, the tendency for two entities to request or desire, the same address.

Another need exists to utilize a pre-existing identifier, such as a telephone number, as at least a portion of a web address.

Still yet another need exists to provide a method for assigning e-mail addresses and web addresses using an easy to associate web-address with a particular person or entity.

### SUMMARY OF THE INVENTION

The present invention recognizes and addresses the foregoing disadvantages, and others of prior art methods. Accordingly, a method for assigning web-page addresses and/or e-mail addresses utilizing telephone numbers as part of the domain name may be performed by or for a host. Specifically, telephone numbers are typically unique to a particular phone location or specific mobile phone. By assigning web-page addresses utilizing the phone number of the applicant as a portion of the web page, a host is able to provide the applicant with a web page that the Internet-literate public may quickly find using a readily known and ascertainable identifier. For some sites, such as a local company, a customer could utilize the local phone book to quickly determine the web address. For other sites, various search engines on the Internet such as People Search™ or Yahoo Yellow Pages™ could allow a person to find a telephone number and then use this number to find an individual's or business' web address.

Additionally, if an entity already has a web site, another web site may be hosted utilizing the telephone number which is then linked to the existing web site. For instance, the telephone number of the applicant is (123) 456-7890, then the server may assign the URL “www.1234567890.theserver.com” to that entity. If the entity already has a web page, such as “www.companyname.com,” then the web page for the address or URL including the telephone number as a sub domain name may simply automatically link people accessing the telephone number site to “www.companyname.com.” Furthermore, the entity may utilize the telephone number web page in any other manner they see fit as well.

Additional objects and advantages of the invention will be set forth in part in the following description, or may be obvious from the description or accompanying drawing, or may be learned through practice of the invention. The accompanying drawing, which is incorporated in and constitutes apart of this specification, together with the description serves to explain the principles of the invention.

### BRIEF DESCRIPTION OF THE DRAWINGS

FIGS. 1 A-D are a flowchart of the preferred method of assigning addresses as taught herein.

### DESCRIPTION OF THE PREFERRED EMBODIMENT

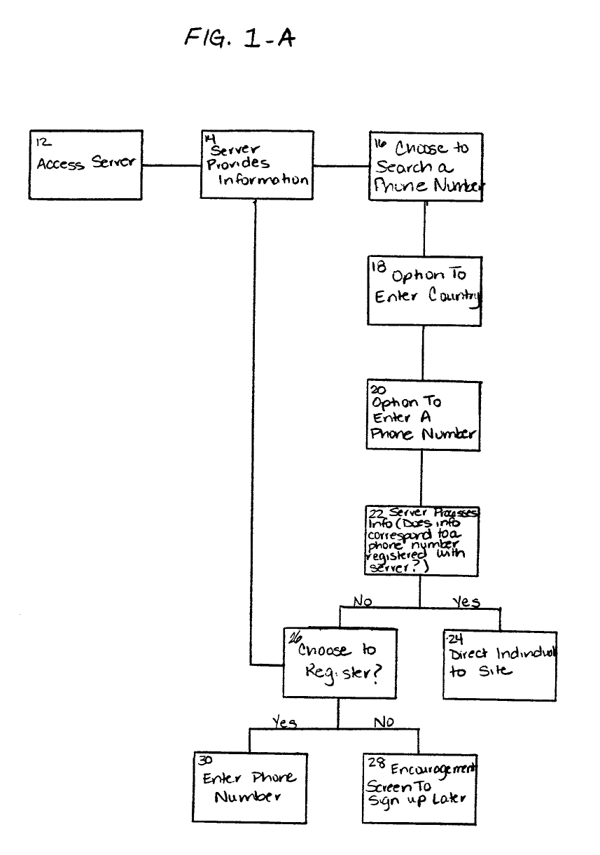

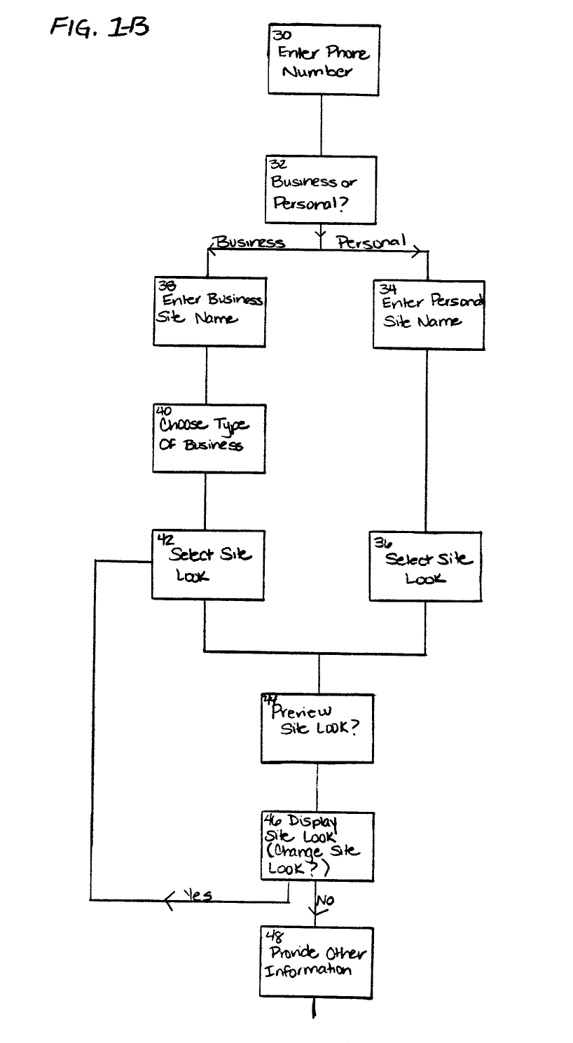

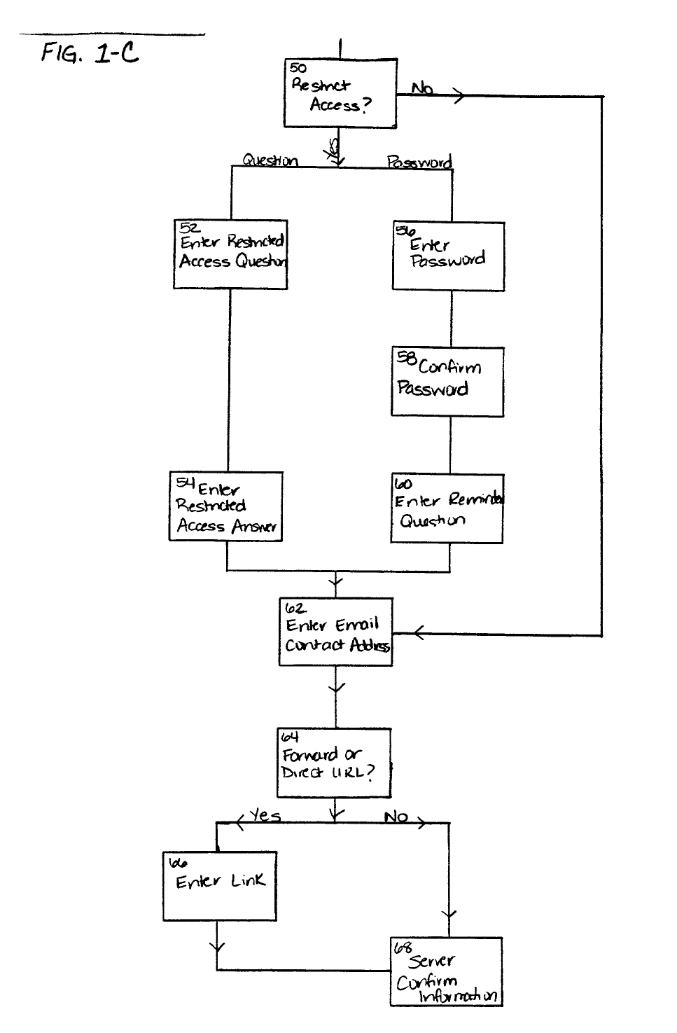

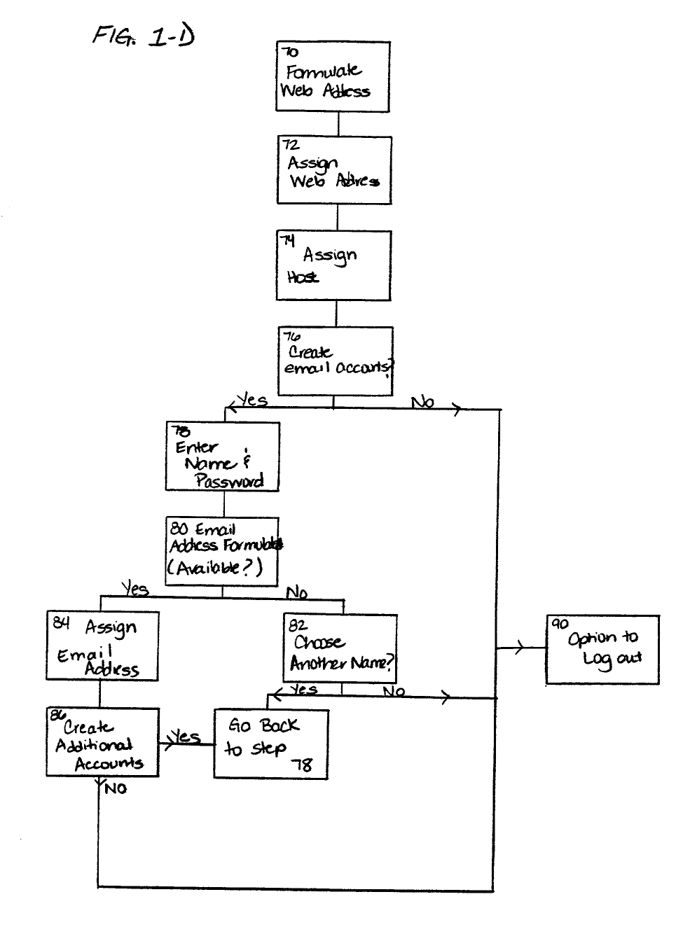

FIG. 1 is a flowchart of the preferred embodiment illustrating the method of assigning or searching for Internet addresses utilizing telephone numbers. In FIG. 1-A the method 10 is illustrated as beginning at step 12. In order to begin the process, the preferred embodiment begins with a potential subscriber, or otherwise interested person, logging onto a particular server's web site such as “www.theserver.com”. Although the process beginning at step 12 contemplates the use of the potential subscriber, or other user, utilizing the Internet to register with a particular server, faxes or other methods of communication could also be utilized to begin this method 10 at step 12.

Once the interested party has accessed the server at step 12, the server will typically provide information at step 14. Such information may include a welcome screen providing information about the service provided by the server, a sign-up opportunity window, advertising, an information section which may provide information about the server company itself, or a search engine to allow the interested party to search for Internet addresses by telephone numbers, name, company name, area (partial address), partial number, business type or any combination of the above.

In the preferred embodiment, the interested party may select from the displayed information display at step 14 the option of searching for a web site by a particular phone number illustrated at step 16. If the interested party elects to search for a web site by a particular phone number, the option of entering in a particular country may be provided for the number at step 18. The interested individual may enter a phone number at step 20. For some numbers, such as international numbers, additional information maybe requested at step 20. One such instance may arise if different prefix codes exist within a particular country. Other prefixes may be provided by the program, such as “011” for international phone numbers, could be provided by the program without prompting the user for this information. Alternately, the individual may be prompted to indicate their country of origin and international calling codes or prefixes can automatically be associated with that individual's record or other information.

By pressing an icon such as a search button or utilizing the enter key on the computer, the information entered by the interested individual may be processed by the server in order to conduct a search. In processing the information entered by the interested person, the server may determine at step 22 whether or not the phone number entered matches one or more phone numbers in the server's database corresponding to an entity which is signed up with the server. If the phone number entered corresponds to a phone number registered with the server, the server may direct the interested individual to the site at step 24 or otherwise provide information about the entity which is registered, or subscribed, with the server. If the phone number matches two different phone numbers, the server may prompt the interested individual to choose between the different numbers based on the country of origin information associated with each phone number, thereby identifying the desired match. If the phone number is not in the database, then the server may provide the interested applicant the opportunity to register that phone number at step 26.

Additionally, if the interested individual views the displayed information in step 14, and then elects to not search for a particular site by phone number at step 16, the interested individual may have the opportunity to sign-up, register, or subscribe, at step 26. If the interested individual elects not to sign-up, some information maybe displayed at step 28 such as encouragement for the individual to try back at a later date or to continue browsing the server's web site.

If the interested applicant elects to sign-up at step 26, the program may request the interested individual to enter a phone number at step 30 or otherwise confirm the number entered at step 20 is the correct number for purposes of registering with the server. Since companies and/or individuals are typically assigned a unique telephone number by a phone company, no two entities should have the same phone number. Different levels of information regarding the phone numbers can be gathered, associated with such numbers, or provided to differentiate between the same 10 digit phone numbers used in different countries.

FIG. 1-B illustrates the registration process, beginning at step 30 when the server requests a phone number and continuing to the next step. At this point, the interested applicant may be asked whether or not the use of the site will be for personal use or for business use at step 32. If personal use is selected, then the applicant may be asked to enter a site name such as “our family's web site” or anything else that may appeal to the applicant at step 34. Next, the individual may enter a site look which would be appropriate for an individual's web site at step 36.

Should the interested applicant elect the business option at step 32, the applicant may once again have the option of entering the site name at step 38, however, it is believed that this type of site name will typically be something similar to “your company name”. Of course, the applicant could call the site by any name desired. Next, the applicant may be asked at step 40 to identify or select its type or line of business in order to assist in establishing a database which may be searched by other attributes other than just telephone numbers. It is anticipated that a number of business types will be preselected from which the applicant may select the business type that is closest to the business of the applicant. Alternatively, the applicant may manually enter in a business type.

In step 42, the applicant may select a “look” for the site from one or more predetermined formats which best reflects the interests of the applicant. At step 42, the applicant is presented with various types of web-page looks, essentially different templates for building the applicant's web site, which may be input, adopted, and/or selected from step 42. Once the applicant has selected a site look at either of steps 36 or 42, the applicant may be provided with an opportunity to preview the site look at step 44. If the applicant elects to preview the site look at step 44, then the sample site look or the actual view of how the applicant's site may look will be displayed at step 46. At step 46, the applicant may then either go back to steps 36 or 42 to select another site look or continue on to enter the applicant's address and/or other information which may be necessary for data collection, billing, or providing other information. Information such as the applicant's street address, city, state, zip code and country are the presently preferred information which are collected by the server from the applicant at step 48. This information may be used to verify that the applicant is the person or entity to whom the issuing phone company has assigned the selected phone number. Other methods for verifying that a phone number is registered only to the actual owner of that phone number may also be envisioned. Presently contemplated methods for ensuring that only the proper entity registers the phone number belonging to that entity include verifying ownership via a return phone call to the telephone number, providing a password to the number sought to be registered, restricting registration of a phone number to applicants who are actually accessing the server via the telephone line associated with the phone number for which registration is sought, or an e-mail communication or some other verifiable communication.

FIG. 1-C continues the registration process. Some applicants may desire to restrict access to certain information regarding their web site. At step 50, after the applicant has been asked to provide information at step 48, the applicant may be provided with the opportunity to restrict access to at least some of the information provided to the server. Such potentially restrictable information may include the company address or other information provided in step 48. If the applicant elects not to restrict access to at least some of the information provided at step 48, the applicant will continue directly to step 62. If the applicant elects to restrict access to information at step 50, then the applicant may enter a restricted access question or password prompt at step 52 followed by an answer to the restricted access question or password prompt at step 54. Accordingly, should someone attempt to access this information of the applicant, the server may present the inquirer with the restricted access question. If the inquirer responds with the correct answer or password initially set by the registrant, then the inquirer would be provided access to this information. However, if the inquirer does not know the answer to the restricted access question, the server would not release the information covered by the restricted access. Different methods may be devised for protecting passwords or restricting access to certain information.

Alternatively, the server may require the applicant to enter a password to allow access to restricted information or alteration of the web site at step 56. The applicant may be given the opportunity to confirm the password at step 58 and then provided with the opportunity to enter a reminder question at step 60. Later modifications to the web site may require the password in order to obtain access thereto.

At step 62, the applicant may be asked to submit an initial contact e-mail address for purposes of assisting and setting up the web address and/or e-mail addresses associated with the web address. At step 64, the server may inquire of the applicant whether or not to forward or otherwise direct interested entities searching by phone numbers to an existing URL site. If the applicant desires to direct interested entities to an existing URL site at step 64, a link may be entered at step 66.

The server may then confirm at least some of the information supplied by the applicant at step 68. This may end the registration process at step 68. As illustrated in FIG. 1-D, the server will then formulate a web address for the applicant utilizing the applicant's phone number as a portion of the URL at step 70. This address preferably will include a reference marker. The reference marker is preferably a domain name related to the server or host. For instance, if the server's name is ABC Server, and the phone number is 1234567890, then the server may formulate the web address of “www.1234567890.abcserver.com” or any other web address including the reference marker and the telephone number.

Applicant's presently preferred reference marker is “dialnow.com”, though a myriad of other reference markers are possible. Applicant's web site, which is operational as of the filing date of this application, is located at “www.dialnow.com” and the disclosure found there, both textual and functional, as of the date of filing is expressly incorporated herein by reference.

At step 72, the web address formulated at step 70 will be assigned to the applicant. Next, the web address assigned in step 72 will be hosted by a host at step 74. The host may or may not be the same entity as the server. The host would typically be provided the restricted access information if entered at steps 50 and 52. Additionally, the host may be provided with the password information entered at steps 54 through 58.

The server utilizes the information provided by the applicant to create a web page to be located at the web address assigned to the applicant.

After the registration process at step 68 or any other appropriate place, the server may provide the registrant with the opportunity to create one or more e-mail accounts such as at step 76. If the applicant does not elect to create an e-mail account at step 76, the registrant may be allowed to end the session at step 90 at this time. Otherwise, if the registrant decides at step 76 to create an e-mail account, the registrant may then be afforded the opportunity to enter a name for the e-mail account and a password at step 78. The program then formulates an e-mail address based on the name provided by the registrant at step 80. The e-mail address will also include the registrant's telephone number as a portion of that e-mail address. Preferably, the e-mail account names associated with a web address would be in the format of “yourname@yourphonenumber.theserver.com.” However, other conventions or formats could also be utilized. The program may then need to check to make sure that the e-mail address is available. For instance, it may be possible that two people at the same telephone number desire the same name for use with their telephone number. If the name is not available, the registrant may be given the opportunity to choose another name at step 82.

If the registrant elects to choose another name at step 82, the registrant may enter another name and password at step 78 and repeat the process. If the registrant does not elect to choose another name at step 82, the registrant may be given the opportunity to exit the session at step 90. If the e-mail address is available at step 80, the program may assign the e-mail address at step 84 to the registrant.

After the creation of a first e-mail account, the registrant may create one or more additional e-mail addresses. At step 86, the registrant may be given the opportunity to create another e-mail account. If the registrant elects to create another account, the registrant will be given the opportunity to enter a name and password at step 78 and repeat the process. Otherwise, if the registrant elects not to create another e-mail account, the registrant may be given the opportunity to end the session at step 90.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

What is claimed is:

1. A method of assigning a computer network address to an entity, the method comprising:
(a) accessing a server;
(b) providing a telephone number to said server;
(c) said server formulating a computer network address, said computer network address incorporating the telephone number as at least a portion of the computer network address;
(d) said server assigning said computer network address to said entity.

2. The method of claim 1 further comprising the step of said server maintaining a database including said assigned computer network address.

3. The method of claim 1 wherein said telephone number is associated with said entity.

4. The method of claim 1 wherein said accessing the server step comprises said entity accessing said server via a computer network.

5. The method of claim 1 further comprising the step of said server automatically creating a web page to be located at said computer network address.

6. The method of claim 5 wherein the step of said server creating a web page to be located at said computer network address comprises receiving information relating to the content of the web page from said entity and generating said web page.

7. The method of claim 6 wherein the content includes a site look.

8. The method of claim 6 wherein the content includes a link to another web address.

9. The method of claim 1 wherein said computer network address further comprises a reference marker.

10. The method of claim 9 wherein said reference marker is a name related to said server.

11. The method of claim 1 comprising the additional step of hosting a web site at said computer network address.

12. The method of claim 1 further comprising the step of assigning at least one e-mail account associated with said network computer address to said entity.

13. The method of claim 12 further comprising the step of hosting said e-mail address.

14. The method of claim 1 wherein said entity provides information to said server to block access to said computer network address or e-mail address from entities accessing said server.

15. The method of claim 1 further comprising providing a password to allow access to restricted information or alteration of the web site.

16. The method of claim 15 wherein said entities provide information to the server to block their computer network address or e-mail address from entities accessing server to search for it.

17. A method of assigning uniform resource locators comprising:
(a) providing a server for hosting web sites;
(b) receiving from a computer of an entity a request message which contains an entity identifier and a telephone number associated with said entity identifier;
(c) extracting the entity identifier and associated telephone number;
(d) formulating a uniform resource locator incorporating the associated telephone number as at least a portion of the uniform resource locator;
(e) providing a database which associates the entity identifier with the uniform resource locator; and
(f) hosting a web page associated with the entity identifier located at the uniform resource locator.

18. The method of claim 17 further comprising providing to the entity instructions for customizing the web page located at the uniform resource locator.

19. The method of claim 17 wherein the uniform resource locator further comprises a reference marker.

20. The method of claim 17 further comprising providing to the entity instructions for restricting access to the web page located at the uniform resource locator.

21. The method of claim 17 further comprising assigning at least one e-mail account associated with the uniform resource locator.

22. The method of claim 17 further comprising:
(a) providing a database of preselected web page formats;
(b) receiving from the entity's computer a selection message choosing one or more preselected web page formats from the database;
(c) generating web page content for the web page located at the uniform resource locator based upon the chosen preselected format.
